(19) United States
(12) Patent Application Publication
(10) Pub. No.: US 2003/0198414 A1
(43) Pub. Date: Oct. 23, 2003

(54) Lubricant line structure for a radially inner surface of a bearing

(75) Inventors: Alex Horng, Kaohsiung (TW); Ching-Sheng Hong, Kaohsiung (TW)

Correspondence Address: Bacon & Thomas, 625 Slaters Lane - 4th Floor, Alexandria, VA, 22314, US

(73) Assignee: Sunonwealth Electric Machine Industry Co., Ltd., Kaohsiung (TW)

(21) Appl. No.: 10/126,579

(22) Filed: Apr. 22, 2002

(51) Int. Cl. F16C 33/10

(52) U.S. Cl. 384/291

(57) ABSTRACT

The lubricant line structure for the radially inner surface of the bearing in accordance with the present invention mainly comprises a plurality of zigzag lubricant lines. The zigzag lubricant lines are symmetrically extended along an axis of the bearing and connected two end surfaces. When a shaft in the bearing is rotated in clockwise or counterclockwise, outer lubricant is sucked into an interior of the bearing so as to form plurality of convergent lubricant points.

### BACKGROUND OF THE INVENTION

1. Field of the Invention

The present invention is related to a lubricant line structure for a radially inner surface of a bearing and more particularly to a zigzag lubricant line symmetrically connects two end surfaces to suck outer lubricant into the bearing, and thereby inner lubricant are forced to form a plurality of convergent lubricant points in the inner surface, while a shaft in this bearing is rotated no matter in clockwise or counterclockwise as well as rotating in free direction.

2. Description of the Related Art

A traditional oil-impregnated bearing utilizes lubricant to maintain lubricity on its radially inner surface for reducing friction. Thus, it is mainly necessary to improve for reducing inner lubricant leakage and friction increased by inadequate inner lubricant. Currently, a washer is available to cover on either end of a bearing in order to reduce or prevent inner lubricant from leakage. However, the washer is incapable of effectively preventing the bearing from inner lubricant leakage. Many other techniques for retaining inner lubricant have evolved over the years.

U.S. Pat. No. 4,883,367, issued on Nov. 28, 1989 to Maruyama, U.S. Pat. No. 5,289,067, issued on Feb. 22, 1994 to Tanaka, and U.S. Pat. No. 6,023,114, issued on Feb. 8, 2000 to Mori, disclose a variety of guiding grooves provided on an inner surface of a oil-impregnated bearing, so as to dynamically balance the entire pressure of inner lubricant. However, these guiding grooves are also incapable of guiding outer lubricant from one end of a bearing to the other end to form convergent lubricant points which can support rotation of a shaft. Meanwhile, inner lubricant leakage still occurs at the two ends of the oil-impregnated bearing.

Certainly, all oil-impregnated bearings cannot absolutely avoid the occurrence of inner lubricant leakage. The oil-impregnated bearing can be compensated for inner lubricant leakage if outer lubricant is guided into an interior of the bearing. In this regard, two ends of the oil-impregnated bearing are necessary to form a guiding structure through which connects to the interior for supplying lubricant instead of inner lubricant leakage.

The present invention intends to provide a zigzag lubricant line extending from one end to another on a radially inner surface of an oil-impregnated bearing. The zigzag lubricant line in accordance with the present invention are used to guide outer lubricant entering into an interior of the bearing to form convergent lubricant points therein in such a way to mitigate and overcome the above problem.

### SUMMARY OF THE INVENTION

The primary objective of this invention is to provide a lubricant line structure for a radially inner surface of a bearing symmetrically connecting two end surfaces so that outer lubricant can be entered into an interior of the bearing, and thus the outer lubricant is sucked into the interior to maintain its lubricity while a shaft in the bearing is rotated.

The secondary objective of this invention is to provide a lubricant line structure for a radially inner surface of a bearing symmetrically extending between two end surfaces, and thus a plurality of convergent lubricant points are formed for supporting a shaft while it is rotated either in clockwise or counterclockwise.

The another objective of this invention is to provide a lubricant line structure for a radially inner surface of a bearing, and thus a plurality of the lubricant lines simplifies the entire structure of the bearing.

The present invention is a lubricant line structure for a radially inner surface of a bearing. The lubricant line structure mainly comprises a plurality of zigzag lubricant lines. The zigzag lubricant lines are symmetrically extended along an axis of the bearing and connected two end surfaces. When a shaft in the bearing is rotated in clockwise or counterclockwise, outer lubricant is sucked into an interior of the bearing so as to form plurality of convergent lubricant points.

Other objectives, advantages and novel features of the invention will become more apparent from the following detailed description and the accompanying drawings.

### BRIEF DESCRIPTION OF THE DRAWINGS

The present invention will now be described in details with references to the accompanying drawings herein:

FIG. 1 is an exploded perspective view of a shaft and a bearing in accordance with a first embodiment of the present invention;

FIG. 2 is a partial cross-sectional view of the shaft and the bearing in accordance with the first embodiment of the present invention;

FIG. 3 is a schematic diagram of a radially inner surface of the bearing in accordance with the first embodiment of the present invention;

FIG. 4 is an exploded perspective view of a shaft and a bearing in accordance with a second embodiment of the present invention;

FIG. 5 is a partial cross-sectional view of the shaft and the bearing in accordance with the second embodiment of the present invention;

FIG. 6 is a schematic diagram of the radially inner surface of the bearing in accordance with the second embodiment of the present invention;

FIG. 7 is an exploded perspective view of a shaft and a bearing in accordance with a third embodiment of the present invention;

FIG. 8 is a partial cross-sectional view of the shaft and the bearing in accordance with the third embodiment of the present invention; and

FIG. 9 is a schematic diagram of the radially inner surface of the bearing in accordance with the third embodiment of the present invention

### DETAILED DESCRIPTION OF THE INVENTION

Referring now to the drawings, there are three embodiments of the present invention shown therein, which include generally a primary bearing member and a secondary shaft member.

The term “free direction”, as used herein, means a rotational direction of a shaft with respect to an axis of a bearing can be chosen. Accordingly, the terms “clockwise” and “counterclockwise” are embodied in the term “free direction”.

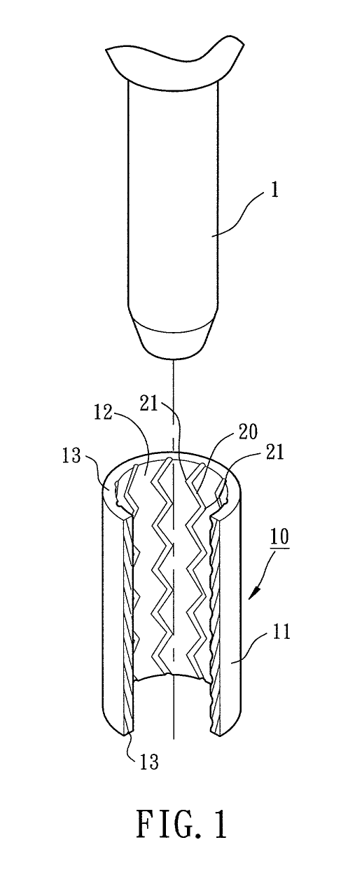

Referring initially to FIGS. 1 through 3, an oil-impregnated bearing 10 in accordance with a first embodiment of the present invention mainly includes a plurality of zigzag lubricant lines designated as numeral 20 and lubricant points thereof as numeral 30 and 31. Much of the other detailed structure of the oil-impregnated bearing 10 is omitted. The oil-impregnated bearing 10 is adapted to rotatably receive a shaft designated as reference 1.

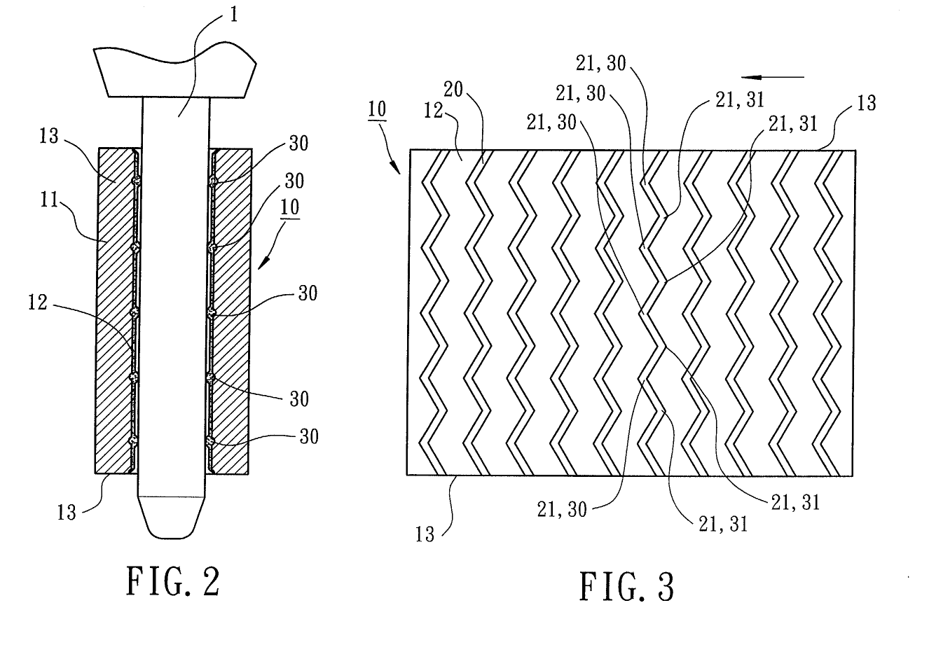

Construction of the oil-impregnated bearing 10 shall be described in detail, referring now to FIGS. 1 and 2. The oil-impregnated bearing 10 in accordance with the first embodiment of the present invention generally includes a radially outer surface 11, a radially inner surface 12, a first end surface 13 and a second end surface 14. The bearing 10 further comprises a plurality of zigzag lubricant lines 20 provided on its radially inner surface 12. Each zigzag lubricant line 20 is provided a plurality of turning points 21 symmetrically distributed at opposite sides with respect to its referred centerline. These turning points are predetermined to form convergent lubricant points while the shaft 1 is rotating.

Referring back to FIG. 2, a gap (not labeled) is formed between the bearing 10 and the shaft 1. Inner lubricant is spread in the gap so that the shaft 1 is smoothly in contact with the inner surface 12 and freely rotated in the bearing 10. and such that friction therebetween is reduced. Meanwhile, some inner lubricants are filled in the zigzag lubricant lines 20 to reservoir in them. The inner lubricant filled in the lubricant lines 20 is simultaneously forced to flow to its turning points 21 and to thereby form convergent lubricant points while the shaft 1 is being rotated. Outer lubricant on the end surfaces is sucked into the gap via the openings of the lubricant lines 20 and then converged at convergent lubricant points. These convergent lubricant points support the rotating shaft 1 that they can maintain indirect friction between the inner surface of the bearing 10 and the shaft 1.

The convergent lubricant points 30 and 31 shall be described in detail, referring now to FIG. 3. The zigzag lubricant lines 20 are extended in parallel and spaced equidistance with each other. The turning point 21 is consisted of a pair of inclined lines. When the shaft 1 is freely rotated, the inner lubricant in the lubricant lines 20 is guided to the turning points 21 to form convergent lubricant points for supporting the shaft 1. The turning points 21 of each lubricant line 20 are symmetrically distributed at opposite sides with respect to its referred centerline and the lubricant points are located at a downstream of a rotational direction of the shaft 1. For example, when the shaft 1 is rotated in counterclockwise (as shown in arrow), a plurality of reverse-convergent lubricant points 30 of each lubricant line 20 is formed in the downstream. By contrast, when the shaft 1 is rotated in clockwise, a plurality of obverse-convergent lubricant points 31 of each lubricant line 20 is formed in the downstream instead of reverse-convergent lubricant points 30. Accordingly, each lubricant line 20 has an array of the convergent lubricant points 30 and 31 symmetrically distributed at opposite sides of its centerline.

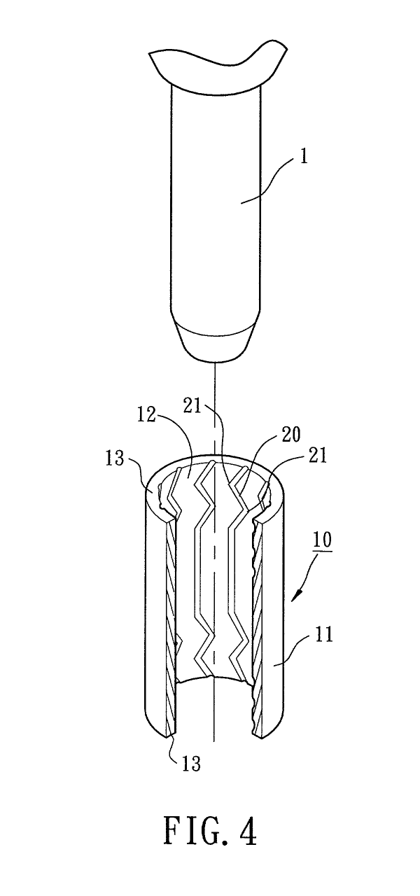

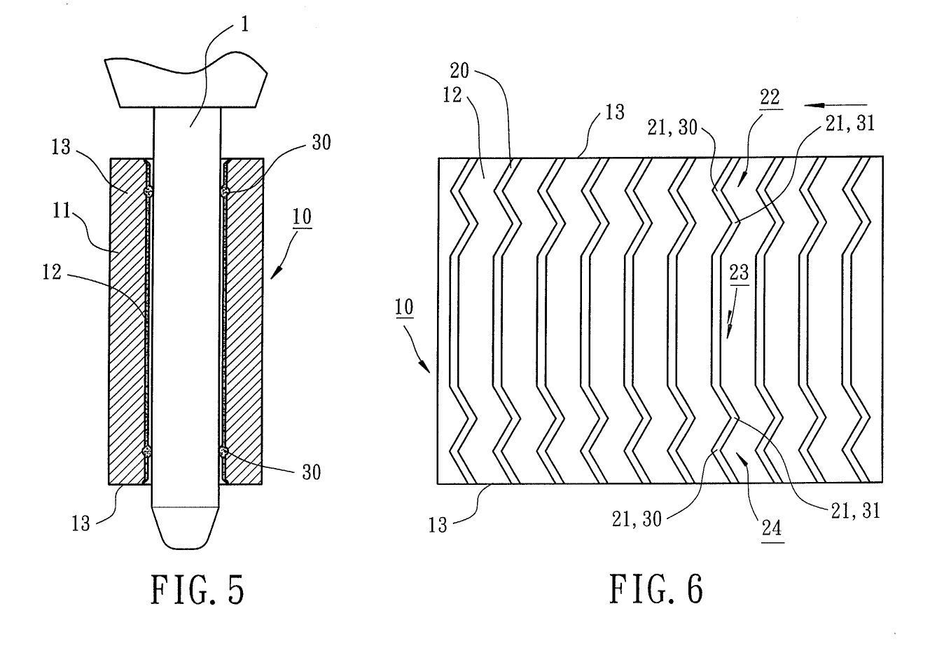

Referring to FIGS. 4 through 6, reference numerals of the second embodiment have applied the identical numerals of the first embodiment. The bearing 10 of the second embodiment has the similar configuration and same function as the first embodiment and the detailed descriptions are omitted. The zigzag lubricant lines 20 are extended on the radially inner surface 12 of the bearing 10. The zigzag lubricant line 20 is consisted of a first zigzag line 22, a reservoir line 23 and a second zigzag line 24. Each zigzag lubricant line 20 is provided a plurality of turning points 21. The reservoir line 23 is adapted to dynamically support the first and second zigzag lines for converging lubricant.

Referring back to FIG. 6, the zigzag lubricant lines 20 are extended in parallel and spaced equidistance with each other. The turning points 21 of each lubricant line 20 are symmetrically distributed at opposite sides with respect to its referred centerline and the lubricant points are located at a downstream of a rotational direction of the shaft 1. For example, when the shaft 1 is rotated in counterclockwise (as shown in arrow), a plurality of reverse-convergent lubricant points 30 of each lubricant line 20 is formed in the downstream. By contrast, when the shaft 1 is rotated in clockwise, a plurality of obverse-convergent lubricant points 31 of each lubricant line 20 is formed in the downstream instead of reverse-convergent lubricant points 30,

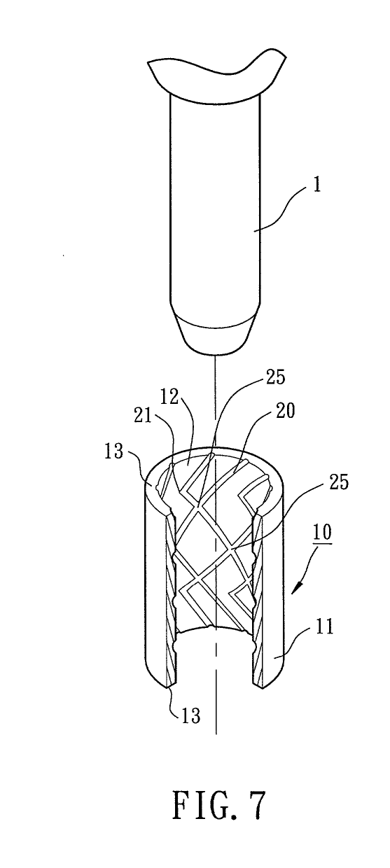

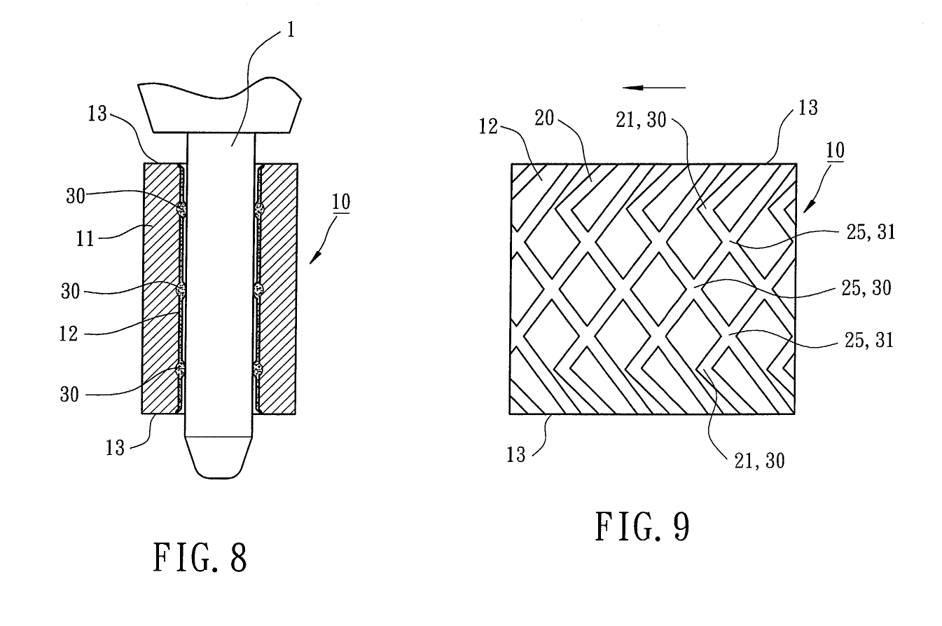

Referring to FIGS. 7 through 9, reference numerals of the third embodiment have applied the identical numerals of the first embodiment. The bearing 10 of the third embodiment has the similar configuration and the same function as the first embodiment and the detailed descriptions are omitted. The zigzag lubricant lines 20 are extended on the radially inner surface 12 of the bearing 10. Some parts of the adjacent lubricant lines 20 are connected to form a plurality of connecting points 25 Each zigzag lubricant line 20 is provided the connecting points 25 in addition to the turning points 21, and therefore provided additional lubricant points.

Referring back to FIG. 9, the turning points 21 and connecting points 25 of each lubricant line 20 are symmetrically distributed at opposite sides with respect to its referred centerline and the lubricant points are located at a downstream of a rotational direction of the shaft 1. For example, when the shaft 1 is rotated in counterclockwise (as shown in arrow), a plurality of reverse-convergent lubricant points 30 of each lubricant line 20 is formed in the downstream. By contrast, when the shaft 1 is rotated in clockwise, a plurality of obverse-convergent lubricant points 31 of each lubricant line 20 is formed in the downstream instead of reverse-convergent lubricant points 30.

Although the invention has been described in details with references to its presently preferred embodiment, it will be understood by one of ordinary skill in the art that various modifications can be made without departing from the spirit and the scope of the invention, as set forth in the appended claims.

What is claimed is:

1. A lubricant line structure for a radially inner surface of a bearing comprising:
a plurality of zigzag lubricant lines axially extended on a radially inner surface; and
a plurality of turning points distributed at opposites sides of a centerline of the zigzag lubricant line to form a plurality of convergent lubricant points, the convergent lubricant points comprising a plurality of reverse-convergent lubricant points and a plurality of obverse-convergent lubricant points;
wherein the reverse-convergent lubricant points are formed when a shaft is rotated in counterclockwise, and the obverse-convergent lubricant points are formed when the shaft is rotated in clockwise.

2. The lubricant line structure as defined in claim 1, wherein the zigzag lubricant line is connected two end surfaces of the bearing, so as to suck outer lubricant into an interior of the bearing.

3. The lubricant line structure as defined in claim 1, wherein the turning points are symmetrically distributed at the opposite sides of the centerline.

4. The lubricant line structure as defined in claim 1, wherein the turning point is consisted of a pair of inclined lines.

5. The lubricant line structure as defined in claim 1, wherein the zigzag lubricant lines are extended in parallel and spaced equidistance with each other.

6. The lubricant line structure as defined in claim 1, wherein the zigzag lubricant line is consisted of a first zigzag line, a reservoir line, and a second zigzag line.

7. The lubricant line structure as defined in claim 1, wherein some parts of the two adjacent zigzag lubricant lines are connected to form a plurality of connecting points, so as to provide a plurality of additional convergent lubricant lines.
